(19) United States
(12) Patent Application Publication
(10) Pub. No.: US 2011/0194081 A1
(43) Pub. Date: Aug. 11, 2011

(54) PROJECTION DISPLAY DEVICE

(75) Inventors: Yusuke YAMAMOTO, Osaka-City (JP); Yuji HASHIBA, Kizugawa-City (JP); Toshihiro SARUWATARI, Kishiwada-City (JP)

(73) Assignee: SANYO ELECTRIC CO., LTD., Moriguchi-City (JP)

(21) Appl. No.: 13/020,526

(22) Filed: Feb. 3, 2011

(30) Foreign Application Priority Data
Feb. 10, 2010 (JP) 2010-028048

(51) Int. Cl. G03B 21/16

(52) U.S. Cl. 353/57

(57) ABSTRACT

A projection display device includes an imager; a cooling portion which supplies an air drawn in from an outside of the projection display device to the imager through an air outlet; an air exhaust portion which discharges an air that has passed the imager to the outside of the projection display device; and a circuit board which is disposed at a position opposite to the air outlet with respect to the imager. In this arrangement, the circuit board is disposed at such a position that the circuit board is not overlapped above the imager, when viewed from an aligning direction of the air outlet and the imager.

This application claims priority under 35 U.S.C. Section 119 of Japanese Patent Application No. 2010-028048 filed Feb. 10, 2010, entitled “PROJECTION DISPLAY DEVICE”. The disclosure of the above application is incorporated herein by reference.

### BACKGROUND OF THE INVENTION

1. Field of the Invention

The present invention relates to a projection display device for enlarging and projecting light modulated by an imager onto a projection plane.

2. Disclosure of Related Art

In a projection display device (hereinafter, called as a “projector”), light modulated by an imager such as a liquid crystal panel is projected onto a projection plane through a projection lens. In a so-called three-panel type projector, three imagers each corresponding to light in a red wavelength band, light in a green wavelength band, and light in a blue wavelength band are provided, and light modulated by the imagers is combined by a light combining element such as a dichroic prism, and the combined light is entered into a projection lens.

In the above projector, the imagers are heated when light is modulated. In view of the above, the projector is incorporated with an arrangement for cooling the imagers.

For instance, an air outlet corresponding to each one of the imagers is disposed between a bottom surface of a main body cabinet and the corresponding imager. An air drawn in from the outside of the projector by an intake fan is supplied to the corresponding imager through the corresponding air outlet. Thereafter, an air that has been warmed by depriving the heat from the imagers is drawn to an exhaust fan and discharged to the outside of the projector. If a flow of air is smooth in the vicinity of the imagers, the imagers can be efficiently cooled.

A circuit board for controlling various driving components of the projector is disposed inside the main body cabinet. The flat-shaped circuit board may be disposed at such a position that the circuit board is overlapped above the other components by a relatively small clearance to miniaturize the projector main body. In this arrangement, the circuit board is disposed immediately above the three imagers.

If the circuit board is disposed above the imagers as described above, the circuit board may obstruct a flow of air drawn out through the air outlets, thereby deteriorating the flow of air. As a result, efficient heat removal from the imagers may not be achieved.

### SUMMARY OF THE INVENTION

A projection display device according to a main aspect of the invention includes an imager; a cooling portion which supplies an air drawn in from an outside of the projection display device to the imager through an air outlet; an air exhaust portion which discharges an air that has passed the imager to the outside of the projection display device; and a circuit board which is disposed at a position opposite to the air outlet with respect to the imager. In this arrangement, the circuit board is disposed at such a position that the circuit board is not overlapped above the imager, when viewed from an aligning direction of the air outlet and the imager.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are perspective views showing an external arrangement of a projector embodying the invention.

FIGS. 2A and 2B are perspective views showing an internal arrangement of the projector as the embodiment.

FIG. 3 is a diagram showing an arrangement of an optical engine and a projection lens unit in the embodiment.

FIG. 4 is a diagram showing an arrangement of a prism unit in the embodiment.

FIG. 5 is a plan view enlargedly showing a control circuit unit and peripheral parts thereof in the embodiment.

FIGS. 6A and 6B are diagrams showing an arrangement of a cooling unit in the embodiment.

FIG. 7 is a diagram showing an arrangement of the cooling unit in the embodiment.

FIG. 8 is a diagram for describing a flow of cooling air that has cooled liquid crystal panels, incident-side polarizers and output-side polarizers in the embodiment.

FIGS. 9A and 9B are diagrams for describing a difference in the flow of cooling air between a case that a circuit board is disposed above an air outlet and a case that a circuit board is not disposed above an air outlet.

FIG. 10 is a diagram for describing a modification on the position of a circuit board.

The drawings are provided mainly for describing the present invention, and do not limit the scope of the present invention.

### DESCRIPTION OF PREFERRED EMBODIMENTS

In the following, an embodiment of the invention is described referring to the drawings.

In this embodiment, a liquid crystal panel 209 for blue light, a liquid crystal panel 214 for green light, and a liquid crystal panel 222 for red light correspond to imagers in the claims. A cooling unit 60 corresponds to a cooling portion in the claims. A first exhaust fan 701 corresponds to an air exhaust portion and an exhaust fan in the claims. An exhaust air passage EW corresponds to an air exhaust portion in the claims. The description regarding the correspondence between the claims and the embodiment is merely an example, and the claims are not limited by the description of the embodiment.

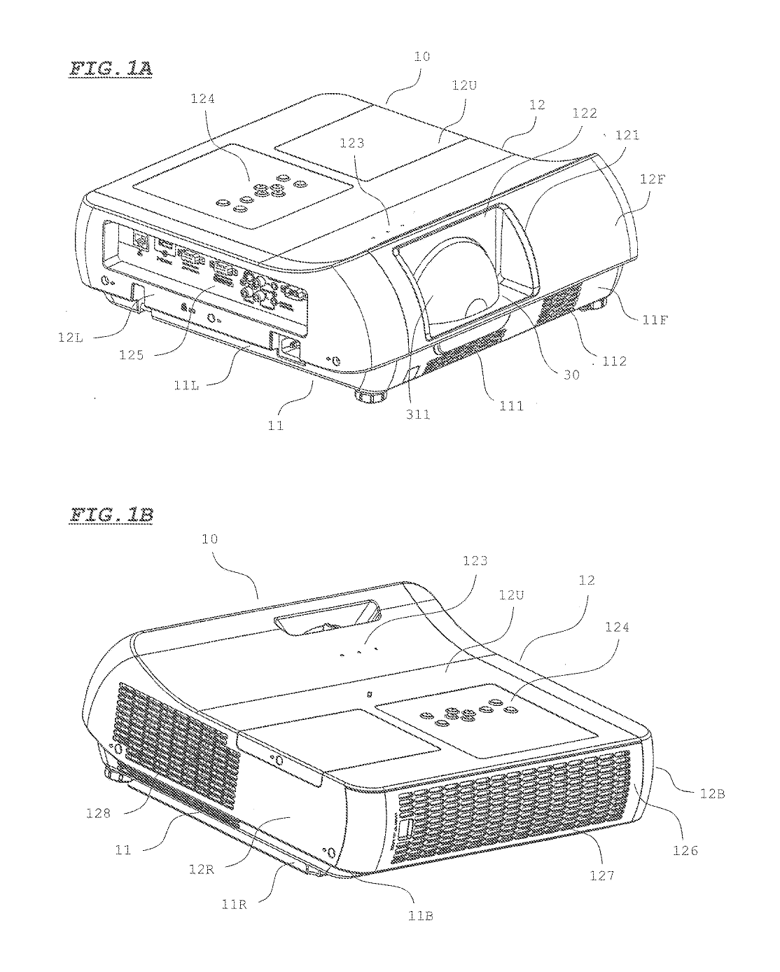

FIGS. 1A and 1B are perspective views showing an external arrangement of a projector. FIG. 1A is a perspective view of the projector when viewed from a front side thereof, and FIG. 1B is a perspective view of the projector when viewed from a rear side thereof.

Referring to FIGS. 1A and 1B, the projector is provided with a main body cabinet 10. The main body cabinet 10 is constituted of a lower cabinet 11, and an upper cabinet 12 to be covered onto the lower cabinet 11 from above.

The lower cabinet 11 has a box-like shape with a small height, and an upper surface thereof is opened. The lower cabinet 11 is configured in such a manner that a front surface 11F is higher than a left side surface 11L, a right side surface 11R, and a back surface 118. The left side surface 11L and the right side surface 11R are configured in such a manner that front ends thereof gradually rise, and are continued to the front surface 11F.

The front surface 11F of the lower cabinet 11 is formed with an air inlet 111. The air inlet 111 is constituted of multitudes of slit holes. The front surface 11F of the lower cabinet 11 is further formed with a sound output port 112. Sounds in accordance with images are outputted through the sound output port 112 at the time of image projection.

The upper cabinet 12 has a box-like shape, and a lower surface thereof is opened. A front portion of the upper cabinet 12 is gradually curved upward over the entirety in left and right directions, and a front surface 12F thereof is directed slightly obliquely upward. The front surface 12F of the upper cabinet 12 is gradually curved when viewed from a lateral direction thereof, and is protruded obliquely upward from the front surface 11F of the lower cabinet 11.

The front surface 12F of the upper cabinet 12 is formed with a rectangular projection port 121 at a position closer to the left side surface of the upper cabinet 12 with respect to the center thereof. A housing portion 122 for housing a lens 311 corresponding to a front end of a projection lens unit 30 is formed at a rear position of the projection port 121.

An upper surface 12U of the upper cabinet 12 is formed with an indicator portion 123 and an operation portion 124. A certain number of LEDs are provided on the indicator portion 123. The user is allowed to confirm whether the projector is in an operating state or a standby state by on/off states of the respective LEDs. The user is also allowed to confirm various error states. A certain number of operation keys are provided on the operation portion 124.

An AV terminal portion 125 is provided on the left side surface 12L of the upper cabinet 12, and various AV terminals are exposed on the left side surface 12L of the upper cabinet 12. AV (Audio Visual) signals are inputted and outputted to and from the projector via the AV terminal portion 125.

The back surface 12B of the upper cabinet 12 is constituted of a detachable rear cover 126. The rear cover 126 is formed with an air inlet 127. The air inlet 127 is constituted of multitudes of slit holes. The right side surface 12R of the upper cabinet 12 is formed with an air outlet 128. The air outlet 128 is constituted of multitudes of slit holes. The external air drawn into the main body cabinet 10 through the air inlet 127 and the air inlet 111 of the lower cabinet 11 is discharged through the air outlet 128 after cooling heat generating parts disposed in the main body cabinet 10, such as liquid crystal panels and a light source lamp.

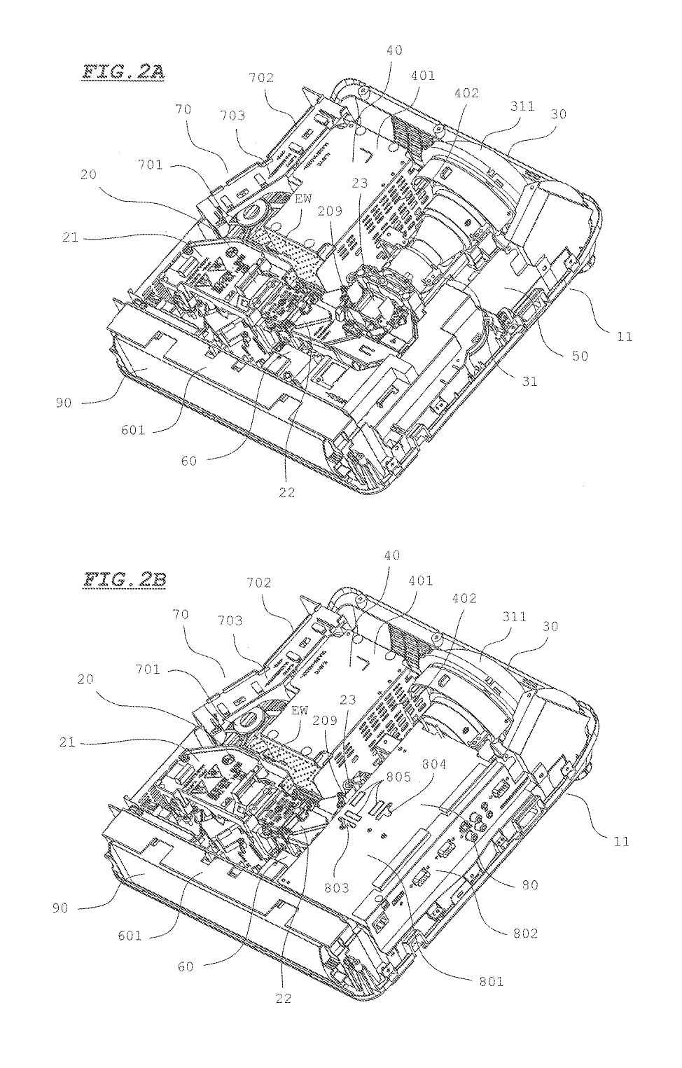

FIGS. 2A and 2B are perspective views showing an internal arrangement of the projector. FIG. 2A is a perspective view of the projector showing a state that the upper cabinet 12 and a control circuit unit 80 are detached, when viewed from the rear side thereof. FIG. 2B is a perspective view of the projector showing a state that the control circuit unit 80 is attached and only the upper cabinet 12 is detached, when viewed from the rear side thereof.

Referring to FIG. 2A, the lower cabinet 11 is internally provided with an optical engine 20, a projection lens unit 30, a main power source unit 90, a sub power source unit 50, a cooling unit 60, and an exhaust fan unit 70.

The optical engine 20 is provided with a light source portion 21 having a light source lamp 201, and an optical system 22 for modulating light from the light source portion 21 to generate image light. The optical engine 20 is disposed slightly rearward with respect to the center of the lower cabinet 11. The optical system 22 extends from the light source portion 21 to the projection lens unit 30 into an L-shape, and includes a prism unit 23 which is disposed at an end of the projection lens unit 30. The projection lens unit 30 is disposed in front of the optical system 22, and slightly closer to the left side than the center of the lower cabinet 11. The projection lens unit 30 is fixed to the lower cabinet 11 via a lens holder 31.

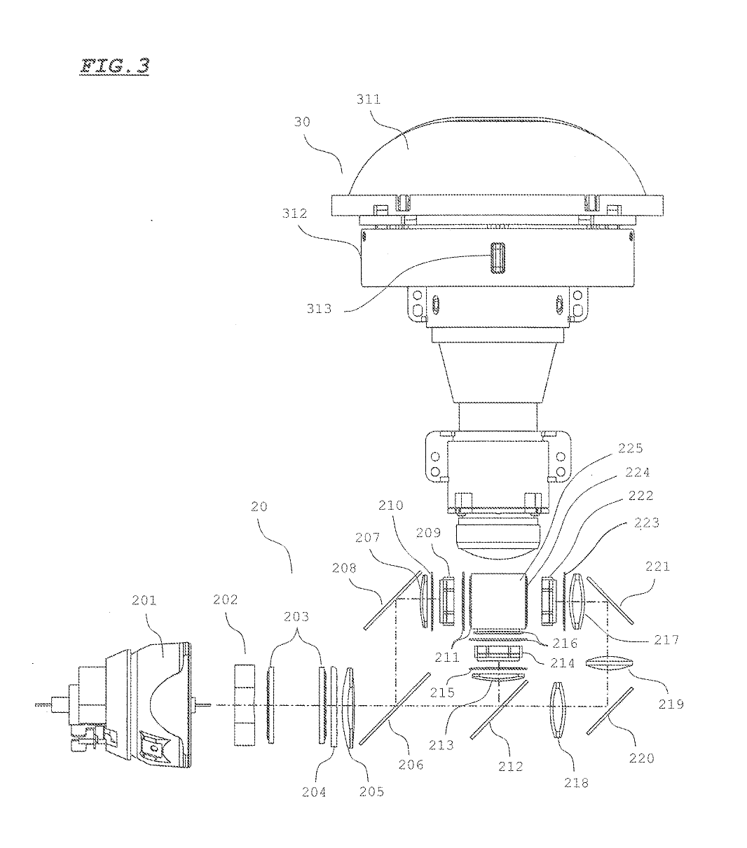

FIG. 3 is a diagram showing an arrangement of the optical engine 20 and the projection lens unit 30.

White light emitted from the light source lamp 201 is transmitted through a condenser lens 202, a fly-eye integrator 203, and a PBS array 204. The fly-eye integrator 203 makes the light amount distributions of light of the each of the colors to be irradiated onto liquid crystal panels (which will be described later) uniform, and the PBS array 204 aligns polarization directions of light directed toward a dichroic mirror 206 in one direction.

Light transmitted through the PBS array 204 is transmitted through a condenser lens 205, and is entered into the dichroic mirror 206.

The dichroic mirror 206 reflects only light (hereinafter, called as “B light”) in a blue wavelength band, and transmits light (hereinafter, called as “G light”) in a green wavelength band and light (hereinafter, called as “R light”) in a red wavelength band, out of the light entered into the dichroic mirror 206.

B light reflected on the dichroic mirror 206 is irradiated onto a liquid crystal panel 209 for B light in a proper irradiation state by a lens function of the condenser lens 205 and a condenser lens 207, and reflection on a reflection mirror 208. The liquid crystal panel 209 is driven in accordance with an image signal for B light to modulate the B light depending on a driven state of the liquid crystal panel 209. One incident-side polarizer 210 is disposed on the incident side of the liquid crystal panel 209. B light is irradiated onto the liquid crystal panel 209 through the incident-side polarizer 210. Further, two output-side polarizers 211 are disposed on the output side of the liquid crystal panel 209, and B light emitted from the liquid crystal panel 209 is entered into the output-side polarizers 211.

G light and R light transmitted through the dichroic mirror 206 are entered into a dichroic mirror 212. The dichroic mirror 212 reflects the G light and transmits the R light.

G light reflected on the dichroic mirror 212 is irradiated onto a liquid crystal panel 214 for G light in a proper irradiation state by a lens function of the condenser lens 205 and a condenser lens 213. The liquid crystal panel 214 is driven in accordance with an image signal for G light to modulate the G light depending on a driven state of the liquid crystal panel 214. One incident-side polarizer 215 is disposed on the incident side of the liquid crystal panel 214, and G light is irradiated onto the liquid crystal panel 214 through the incident-side polarizer 215. Further, two output-side polarizers 216 are disposed on the output side of the liquid crystal panel 214, and G light emitted from the liquid crystal panel 214 is entered into the output-side polarizers 216.

R light transmitted through the dichroic mirror 212 is irradiated onto a liquid crystal panel 222 for R light in a proper irradiation state by a lens function of the condenser lens 205, 217, and relay lenses 218 and 219, and reflection on reflection mirrors 220 and 221. The liquid crystal panel 222 is driven in accordance with an image signal for R light to modulate the R light depending on a driven state of the liquid crystal panel 222. One incident-side polarizer 223 is disposed on the incident side of the liquid crystal panel 222, and R light is irradiated onto the liquid crystal panel 222 through the incident-side polarizer 223. Further, one output-side polarizer 224 is disposed on the output side of the liquid crystal panel 222, and R light emitted from the liquid crystal panel 222 is entered into the output-side polarizer 224.

B light, G light, and R light modulated by the liquid crystal panels 209, 214, and 222 are transmitted through the output-side polarizers 211, 216, and 224, and entered into a dichroic prism 225. The dichroic prism 225 reflects B light and R light, and transmits G light, out of the B light, the G light, and the R light, to thereby combine the B light, the G light, and the R light. Thus, image light after the color combination is projected toward the projection lens unit 30 from the dichroic prism 225.

The projection lens unit 30 is provided with a certain number of lenses, and enlarges and projects the entered image light onto a screen. The projection lens unit 30 is configured as a short focal length type, and a large sized lens 311 is included at a front end of the projection lens unit 30. Image light is emitted slightly obliquely upward from the lens 311.

The projection lens unit 30 is further provided with a focus ring 312. The focus ring 312, is formed with a focus lever 313. When the focus lever 313 is operated, the focus ring 312 is pivotally moved, and a focus lens (not shown) disposed in the projection lens unit 30 is moved in association with the focus ring 312. Thus, by operating the focus lever 313, focus for a projected image is adjusted.

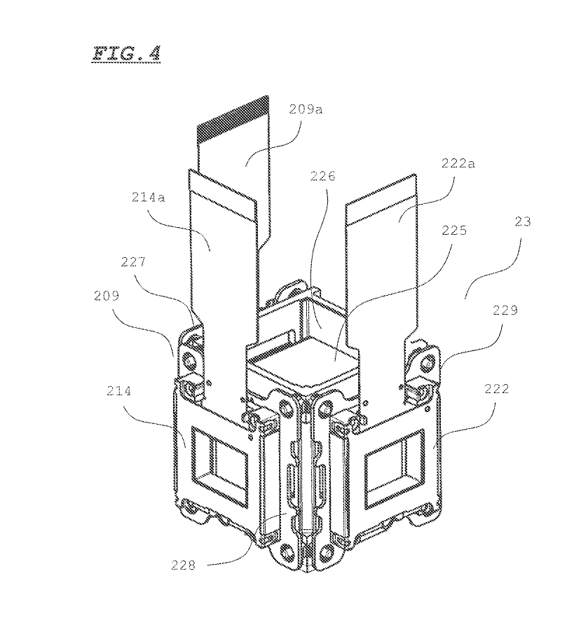

FIG. 4 is a diagram showing an arrangement of the prism unit 23.

The prism unit 23 is configured in such a manner that the liquid crystal panels 209, 214, and 222; the output-side polarizers 211, 216, and 224; and the dichroic prism 225 are assembled on a prism holder 226.

The liquid crystal panels 209, 214, and 222 are respectively fixed to the prism holder 226 via brackets 227, 228, and 229 in such a manner that the liquid crystal panels face three surfaces of the cubic dichroic prism 225. Flexible substrates 209a, 214a, and 222a mounted with various signal lines extend upward from the liquid crystal panels 209, 214, and 222.

Referring back to FIG. 2A, the main power source unit 40 is disposed on the right side of the projection lens unit 30, and the sub power source unit 50 is disposed on the left side of the projection lens unit 30. The main power source unit 40 is provided with a power source circuit within a housing 401, and supplies an electric power to each of the electrical components of the projector. The housing 401 is formed with a vent 402 constituted of multitudes of holes on a side surface thereof on the side of the projection lens unit 30. Another vent (not shown) is formed on the opposite side surface of the housing 401.

The sub power source unit 50 is provided with a noise filter and a smoothing circuit, and supplies an electric power from an inputted commercial AC power source to the main power source unit 40 after noise removal.

The cooling unit 60 is disposed behind the optical engine 20. The cooling unit 60 is provided with plural intake fans. An air inlet portion 601 of the cooling unit 60 is formed at a rear end of the lower cabinet 11. A filter unit 90 is detachably attached to the air inlet portion 601. The filter unit 90 has filters of different mesh sizes to stepwise remove dusts or fumes in an external air drawn in through an air inlet 127 by the respective filters depending on the mesh sizes.

The cooling unit 60 supplies the external air drawn in through the air inlet 127 (see FIG. 1B) of the main body cabinet 10 to the main heat generating parts of the optical engine 20 such as the liquid crystal panels 209, 214, and 222 to thereby cool the heat generating parts. The detailed arrangement of the cooling unit 60 will be described later.

The exhaust fan unit 70 is disposed on the right side of the main power source unit 40, and at a right end of the lower cabinet 11. The exhaust fan unit 70 is constituted of a first exhaust fan 701, a second exhaust fan 702, and a fan holder 703 for fixedly holding the first exhaust fan 701 and the second exhaust fan 702 to the lower cabinet 11.

The first exhaust fan 701 has an air in-take surface thereof being tilted slightly obliquely rearward with respect to the left side surface of the main body cabinet 10. The first exhaust fan 701 discharge, to the outside, an air that has been warmed by cooling the heat generating parts (such as the liquid crystal panels 209, 214, and 222; and the light source lamp 201) inside the optical engine 20. The first exhaust fan 701 also discharges, to the outside, an air that has been drawn in through an air inlet 111 (see FIG. 1A) and warmed by cooling the projection lens unit 30.

The second exhaust fan 702 has an air in-take surface thereof being directed to the main power source unit 90. The second exhaust fan 702 discharges, to the outside, an air that has been warmed by cooling the main power source unit 40.

An exhaust air passage EW extends from the vicinity of the liquid crystal panel 209 toward the first exhaust fan 701 by increasing the clearance between the optical engine 20 and the main power source unit 40 disposed in front of the optical engine 20. The exhaust air passage EW is shown by the broken line portion in FIGS. 2A and 2B.

Referring to FIG. 2B, the control circuit unit 80 is disposed on the side of the left side surface of the lower cabinet 11. The control circuit unit 80 is constituted of a circuit board 801, and an AV terminal substrate 802 mounted on a left end of the circuit board 801. The circuit board 801 has a rectangular shape, with a front end and a rear end thereof extending along the longitudinal direction thereof. The circuit board 801 is mounted with a control circuit for controlling various driving components such as the liquid crystal panels 209, 214, and 222; and the light source lamp 201. The circuit board 801 is disposed above the projection lens unit 30, the optical engine 20, and the cooling unit 60 with a relatively small clearance.

Further, the circuit board 801 is formed with an opening 803 through which the flexible substrate 214a of the liquid crystal panel 214 is exposed on a top surface of the circuit board 801. The circuit board 801 is further formed with an opening 804 through which the flexible substrate 222a of the liquid crystal panel 222 is exposed on the top surface of the circuit board 801. The circuit board 801 is further provided with three connectors 805. The flexible substrates 214a and 222a exposed on the top surface of the circuit board 801 are connected to the corresponding connectors 805. Further, the flexible substrate 209a of the liquid crystal panel 209 which is also exposed on the top surface of the circuit board 801 is connected to the corresponding connector 805.

Various AV terminals are mounted on the AV terminal substrate 802. As described above, when the upper cabinet 12 is mounted on the lower cabinet 11, the AV terminals are exposed on the AV terminal portion 125.

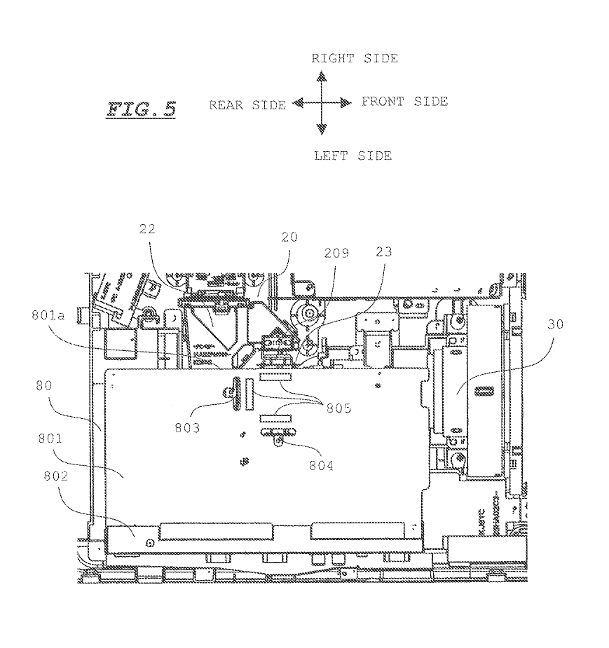

FIG. 5 is a plan view enlargedly showing the control circuit unit 80 and peripheral parts thereof.

As shown in FIG. 5, the control circuit unit 80 is disposed at a position closer to the left side than the liquid crystal panel 209 for blue light. Specifically, a right end 801a of the circuit board 801 is located on a slightly left side of the liquid crystal panel 209 for blue light. With this arrangement, when viewed from above, whereas an upper space of the liquid crystal panels 222 for red light and the liquid crystal panel 214 for green light out of the three liquid crystal panels 209, 214, and 222 is covered by the circuit board 801, an upper space of the liquid crystal panel 209 for blue light is not covered by the circuit board 801. In this embodiment, the two output-side polarizers 211 on the output side of the liquid crystal panel 209 for blue light are covered by the right end of the circuit board 801. Alternatively, it is possible to dispose the two output-side polarizers 211 at such positions that the two output-side polarizers 211 are not covered by the circuit board 801, as well as the liquid crystal panel 209 for blue light.

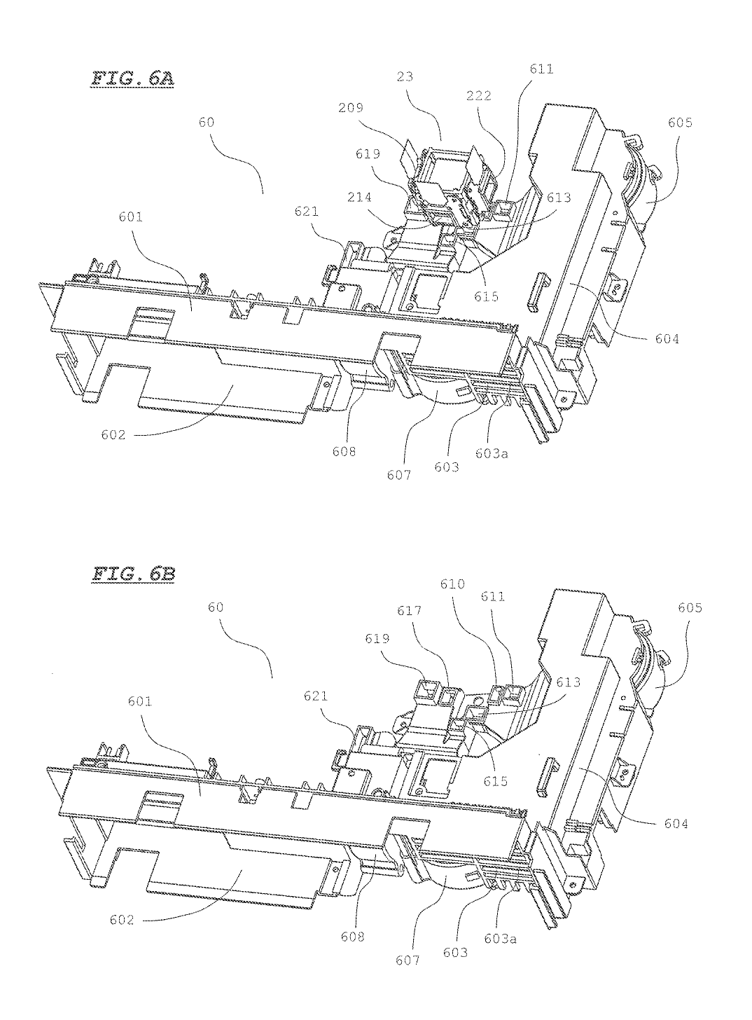

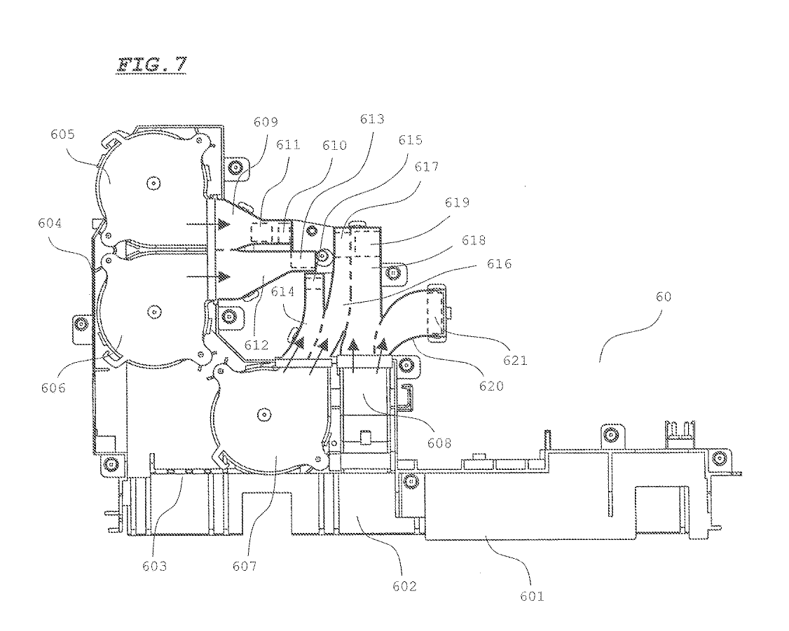

FIGS. 6A, 6B, and 7 are diagrams showing an arrangement of the cooling unit 60. FIGS. 6A and 6B are perspective views of the cooling unit 60. FIG. 6A shows only the prism unit 23 out of the constituent elements of the optical engine 20, along with the cooling unit 60. FIG. 7 is a bottom view of the cooling unit 60.

Referring to FIGS. 6A and 6B, the air inlet portion 601 has a housing portion 602 for housing the filter unit 90 therein. A rear wall of the housing portion 602 is formed with an air inlet 603. A grid portion 603a is formed in the air inlet 603. An external air from which dusts and the like are removed by the filter unit 90 (see FIG. 2A) is drawn into a fan casing 604 through the air inlet 603, as an air for cooling (hereinafter, called as “cooling air”).

Referring to FIG. 7, four intake fans (a first intake fan 605, a second intake fan 606, a third intake fan 607, and a fourth intake fan 608) are disposed in the fan casing 604. A cooling air is drawn to the intake fans 605 through 608 through the inside of the fan casing 609.

A first duct 609 is connected to the first intake fan 605. Two air outlets 610 and 611 are formed in a distal end of the first duct 609. A second duct 612 is connected to the second intake fan 606. An air outlet 613 is formed in a distal end of the second duct 612.

A third duct 614 and a fourth duct 616 are connected to the third intake fan 607. An air outlet 615 is formed in a distal end of the third duct 614. Further, an air outlet 617 is formed in a distal end of the fourth duct 616. A fifth duct 618 and a sixth duct 620 are connected to the fourth intake fan 608. An air outlet 619 is formed in a distal end of the fifth duct 618. Further, an air outlet 621 is formed in a distal end of the sixth duct 620.

Referring back to FIGS. 6A and 6B, the air outlet 610 and the air outlet 611 are positioned below the liquid crystal panel 222 for red light. Further, the air outlet 613 and the air outlet 615 are positioned below the liquid crystal panel 214 for green light. Furthermore, the air outlet 617 and the air outlet 619 are positioned below the liquid crystal panel 209 for blue light. In addition, the air outlet 621 is positioned below a PBS array 204 (not shown in FIGS. 6A and 6B), which is not shown in FIGS. 6A and 6B.

When the four cooling fans 605, 606, 607, and 608 are driven, a cooling air is supplied toward the output-side polarizer 224 (not shown in FIGS. 6A and 6B) through the air outlet 610, and a cooling air is supplied toward the incident-side polarizer 223 (not shown in FIGS. 6A and 6B) and toward the liquid crystal panel 222 for red light through the air outlet 611. Further, a cooling air is supplied toward the output-side polarizers 216 (not shown in FIGS. 6A and 6B) through the air outlet 613, and a cooling air is supplied toward the incident-side polarizer 215 (not shown in FIGS. 6A and 6B) and toward the liquid crystal panel 214 for green light through the air outlet 611. Furthermore, a cooling air is supplied toward the output-side polarizers 211 (not shown in FIGS. 6A and 6B) through the air outlet 617, and a cooling air is supplied toward the incident-side polarizer 210 (not shown in FIGS. 6A and 6B) and toward the liquid crystal panel 209 for blue light through the air outlet 619. In addition, a cooling air is supplied toward the PBS array 204 through the air outlet 621.

In this way, the liquid crystal panels 209, 214, and 222; the incident-side polarizers 210, 215, and 223; and the output-side polarizers 211, 216, and 224 are cooled by the cooling airs. Further, the PBS array 204 is also cooled by the cooling air. Hereinafter, in the case where each set of a liquid crystal panel, an incident-side polarizer, and an output-side polarizer or polarizers for each of the color lights is generically referred to, these sets are particularly called as “the liquid crystal panel 209 and the relevant elements”, “the liquid crystal panel 214 and the relevant elements”, and “the liquid crystal panel 222 and the relevant elements”.

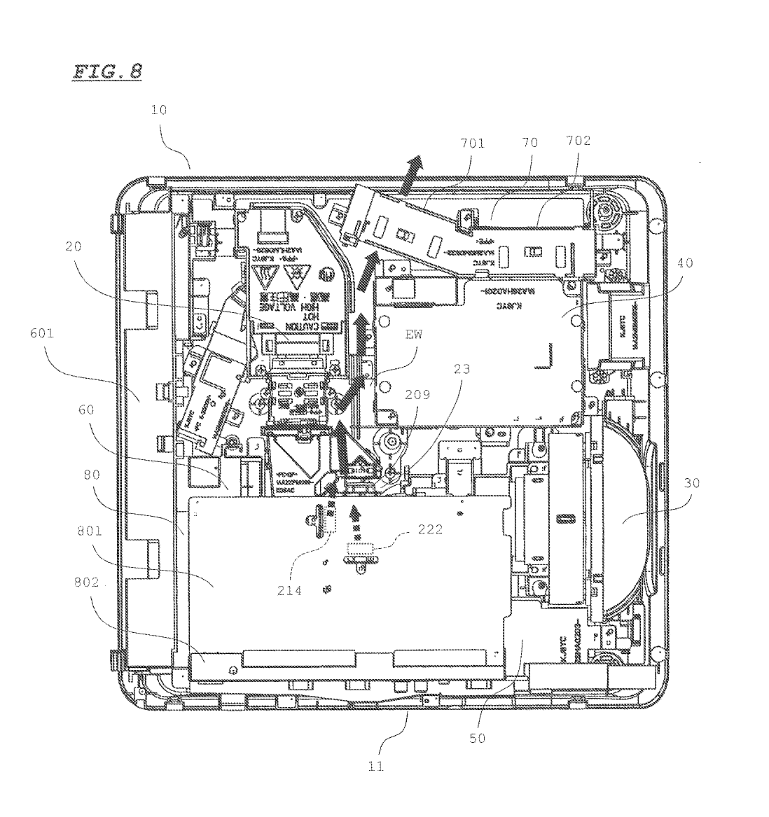

FIG. 8 is a diagram for describing a flow of cooling air after the liquid crystal panels 209, 214, 222, and the relevant elements have been cooled.

When the first exhaust fan 701 is driven, an air in the vicinity of the prism unit 23 is mainly drawn to the first exhaust fan 701 through the exhaust air passage EW. Then, as shown by the arrows in FIG. 8, the cooling air that has cooled the liquid crystal panels 209, 214, 222, and the relevant elements is drawn to the first exhaust fan 701 through the exhaust air passage EW, and is discharged to the outside. A part of the cooling air is directed toward the first exhaust fan 701 while passing a clearance between the top surfaces of the main power source unit 40 and the optical engine 20, and the upper cabinet 12.

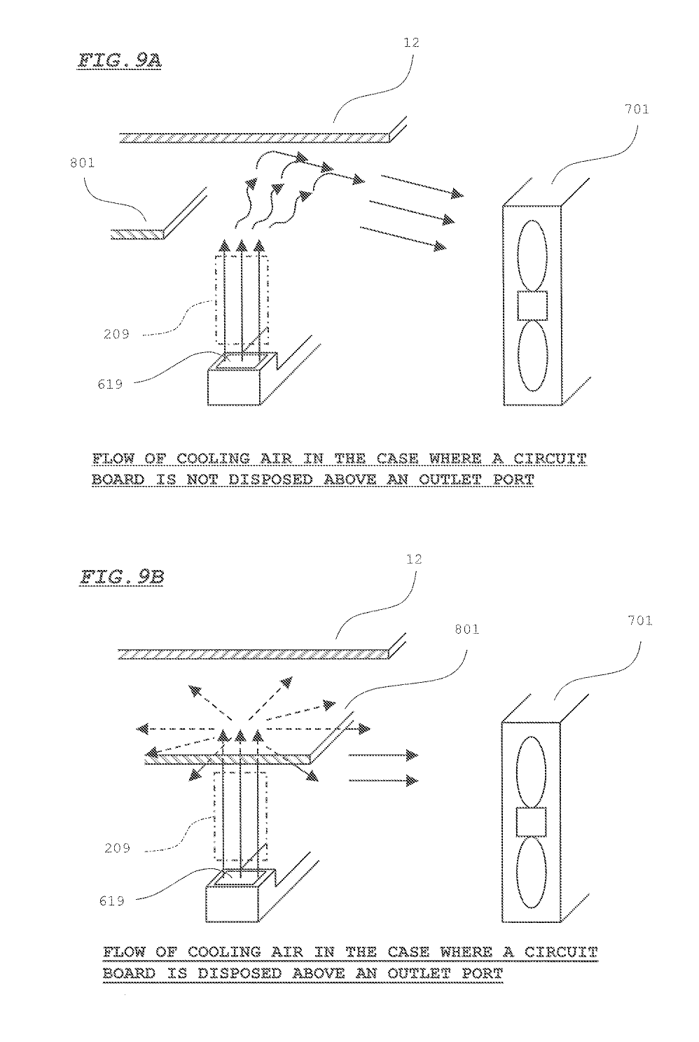

FIG. 9A is a diagram schematically showing a flow of cooling air which is drawn out through the air outlet 619. In FIG. 9B, a flow of cooling air in the case where the circuit board 801 is disposed above the air outlet 619 is schematically shown as a comparative example.

As shown in FIG. 9B, in the case where the circuit board 801 is disposed above the air outlet 619, the distance from the air outlet 619 to the circuit board 801 is relatively short. As a result, as shown by the arrows in FIG. 9B, a cooling air that has cooled the liquid crystal panel 209 impinges against the back surface of the circuit board 801 with a relatively large force, and scatters in different directions. Accordingly, a warmed air is likely to stagnate in the vicinity of the liquid crystal panel 209, with the result that the cooling efficiency for the liquid crystal panel 209 is lowered.

On the other hand, as shown in FIG. 9A, in the case where the circuit board 801 is not disposed above the air outlet 619, the distance from the air outlet 619 to the upper cabinet 12 is relatively long. As a result, as shown by the arrows in FIG. 9A, the force of a flow of cooling air that has cooled the liquid crystal panel 209 is weakened before the cooling air reaches the upper cabinet 12, and the cooling air is gradually merged into a flow of air generated by the first exhaust fan 701. Accordingly, the cooling air is allowed to flow toward the first exhaust fan 701, and even if a part of the cooling air has impinged against the back surface of the upper cabinet 12, the cooling air is less likely to scatter in different directions. Thus, the cooling air is less likely to stagnate in the vicinity of the liquid crystal panel 209, and is smoothly guided toward the first exhaust fan 701 by a suction force by the first exhaust fan 701. As a result, the cooling efficiency for the liquid crystal panel 209 is enhanced.

As described above, in this embodiment, since the cooling efficiency for the liquid crystal panel 209 for blue light, which is particularly likely to be heated, is enhanced, it is possible to effectively suppress deterioration of the characteristics of the liquid crystal panel 209.

In this embodiment, the circuit board 801 is disposed above the output-side polarizers 211 for blue light. However, as described above, since the upper space of the liquid crystal panel 209 disposed immediately in proximity to the output-side polarizers 211 is opened, a cooling air that has been drawn out through the air outlet 617 and passed the output-side polarizers 211 is easily guided to a site where the circuit board 801 is not disposed, in other words, to a position above the liquid crystal panel 209. Accordingly, the cooling efficiency for the output-side polarizers 211 is relatively good. However, since the output-side polarizers 211 for blue light are likely to be heated, in order to enhance the cooling efficiency, it is desirable to dispose the circuit board 801 at such a position that the upper space of the output-side polarizers 211 is not covered by the circuit board 801 as well as the liquid crystal panel 209 for securing a smooth flow of cooling air.

In this embodiment, the circuit board 801 is disposed above the liquid crystal panel 214 for green light and the liquid crystal panel 222 for red light. As a result, a cooling air that has cooled the liquid crystal panels 214 and 222 may likely to impinge against the circuit board 801, scatter in different directions, and stagnate in the vicinity of the liquid crystal panels 214 and 222.

However, in this embodiment, as described above, since a smooth flow of cooling air can be secured in the vicinity of the liquid crystal panel 209 for blue light, which is disposed downstream of a flow of cooling air directed toward the first exhaust fan 701 through the exhaust air passage EW, the air in the vicinity of the liquid crystal panels 214 and 222 is also allowed to flow smoothly by the smooth flow of cooling air in the vicinity of the liquid crystal panel 209. Further, there is no or less likelihood that a cooing air that has passed the liquid crystal panel 209 for blue light may impinge against the circuit board 801 and be directed toward the liquid crystal panel 214 for green light and toward the liquid crystal panel 222 for red light. Accordingly, there is no or likelihood that the flow of cooling air that has passed the liquid crystal panel 214 for green light and the liquid crystal panel 222 for red light may be obstructed by the cooling air that has passed the liquid crystal panel 209 for blue light and has been scattered by the circuit board 801.

As described above, in this embodiment, it is possible to secure a smooth flow of cooling air that has passed the liquid crystal panel 214 for green light and the liquid crystal panel 222 for red light, as well as the cooling air that has passed the liquid crystal panel 209 for blue light. Accordingly, it is possible to enhance the cooling efficiency for the liquid crystal panels 209, 214, and 222 as a whole. Further, since an inner pressure in the vicinity of the liquid crystal panels 209, 214, and 222 is lowered by the smooth flow of cooling air, the air supply amount of cooling air through the air outlets 610, 611, 613, 615, 617, and 619 is also increased. Accordingly, it is possible to enhance the cooling effect for the liquid crystal panels 209, 214, and 222, and the relevant elements. Further, it is possible to reduce the rotating number of the first exhaust fan 701 by the enhanced cooling effect to thereby operate the projector with less noise.

Considering only the air exhaust efficiency of cooling air, it is preferable not to dispose the circuit board 801 above all the liquid crystal panels 209, 214, and 222. However, if, for instance, the circuit board 801 is disposed at such a position that the circuit board 801 is not overlapped above all the liquid crystal panels 209, 214, and 222, it is necessary to modify the arrangement for securing an installation space for the circuit board 801, which may resultantly increase the size of the main body cabinet 10. Further, since the above arrangement increases the distance between the liquid crystal panel 209, 214, 222; and the circuit board 801, it is necessary to increase the length of various signal lines (in this embodiment, the flexible substrates 209a, 214a, and 222a) extending from the liquid crystal panels 209, 214, and 222. This may obstruct efficient connection of the signal lines.

In this embodiment, the projector is configured in such a manner that only the liquid crystal panel 209 for blue light, which is disposed closest to the first exhaust fan 701, is not covered by the circuit board 801. Accordingly, it is possible to dispose the circuit board 801 with less positional constraints, and there is no or less likelihood that the size of the projector main body may be unduly increased resulting from mounting of the circuit board 801 at an unintended position.

Further, in this embodiment, since the exhaust air passage EW extends from the vicinity of the first exhaust fan 701 toward the liquid crystal panel 209, the cooling air that has cooled the liquid crystal panels 209, 214, 222, and the relevant elements can be more smoothly discharged to the outside through the exhaust air passage EW.

The embodiment of the invention has been described as above. The invention, however, is not limited to the foregoing embodiment, and the embodiment of the invention may be modified in various ways other than the above.

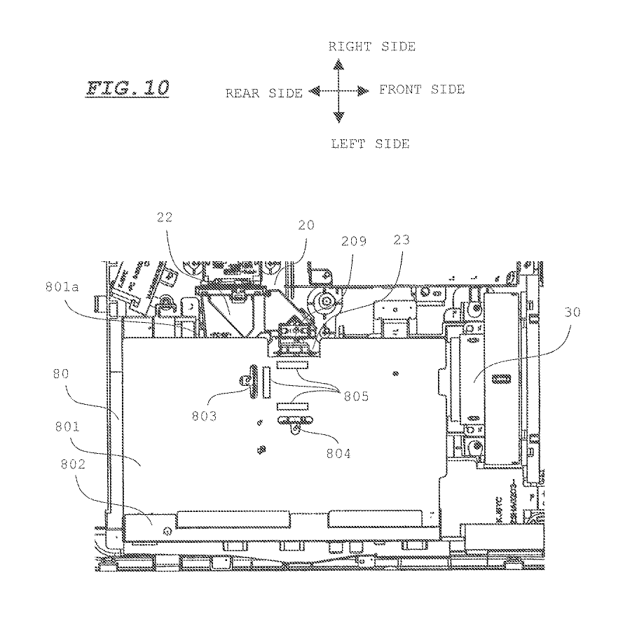

For instance, in this embodiment, as shown in FIG. 5, the entirety of the circuit board 801 is disposed on the left side of the liquid crystal panel 209 for blue light so that the circuit board 801 is not overlapped above the liquid crystal panel 209 for blue light. Alternatively, as shown in FIG. 10, the circuit board 801 itself may be disposed at such a position that a right end 801a of the circuit board 801 is positioned on the right side of the liquid crystal panel 209 for blue light. Then, a portion of the circuit board 801 corresponding to the liquid crystal panel 209 for blue light may be cut away so that the circuit board 801 is not overlapped above the liquid crystal panel 209 for blue light. The above modification enables to increase the size of the circuit board 801. Further alternatively, a portion of the circuit board 801 corresponding to a position above the liquid crystal panel 214 for green light and/or the liquid crystal panel 222 for red light may be cut away to secure a smooth flow of air.

Furthermore, in this embodiment, the liquid crystal panel 209 for blue light is disposed at a position closest to the first exhaust fan 701, in other words, disposed most downstream of the flow of air toward the first exhaust fan 701 so that the circuit board 801 is not overlapped above the liquid crystal panel 209 for blue light. Alternatively, for instance, the liquid crystal panel 222 for red light may be disposed most downstream of the flow of air toward the first exhaust fan 701 so that the circuit board 801 is not overlapped above the liquid crystal panel 222 for red light.

However, the liquid crystal panel 209 for blue light is more likely to be heated, as compared with the liquid crystal panel 222 for red light. Accordingly, as described above in the embodiment, it is desirable to dispose the circuit board 801 at such a position that the circuit board 801 is not overlapped above the liquid crystal panel 209 for blue light to thereby enhance the cooling efficiency for the liquid crystal panel 209 for blue light.

Furthermore, in this embodiment, the circuit board 801 is disposed at such a position that the circuit board 801 is not overlapped above only one of the liquid crystal panels. Alternatively, the circuit board 801 may be disposed at such a position that the circuit board 801 is not overlapped above two or all of the three liquid crystal panels. However, as described above, considering the positional constraints of the circuit board 801, it is desirable to dispose the circuit board 801 at such a position that the circuit board 801 is not overlapped above a liquid crystal panel disposed most downstream of the flow of air toward the first exhaust fan 701. The embodiment of the invention may be changed or modified in various ways as necessary, as far as such changes and modifications do not depart from the scope of the claims of the invention hereinafter defined.

What is claimed is:

1. A projection display device comprising:
an imager;
a cooling portion which supplies an air drawn in from an outside of the projection display device to the imager through an air outlet;
an air exhaust portion which discharges an air that has passed the imager to the outside of the projection display device; and
a circuit board which is disposed at a position opposite to the air outlet with respect to the imager, wherein
the circuit board is disposed at such a position, that the circuit board is not overlapped above the imager, when viewed from an aligning direction of the air outlet and the imager.

2. The projection display device according to claim 1, wherein
a plurality couples of the imager and the air outlet corresponding to the imager are disposed in a direction perpendicular to the aligning direction, and
the circuit board is disposed at such a position that the circuit board is not overlapped above at least one of the imagers, when viewed from the aligning direction.

3. The projection display device according to claim 2, wherein
the imagers are three imagers which modulate light in a red wavelength band, light in a green wavelength band, and light in a green wavelength band, and
the circuit board is disposed at such a position that the circuit board is not overlapped above at least the imager which modulate the light in the blue wavelength band, when viewed from the aligning direction.

4. The projection display device according to claim 2, wherein
the circuit board is disposed at such a position that the circuit board is not overlapped above only one of the imagers, when viewed from the aligning direction.

5. The projection display device according to claim 4, wherein
the imager which is not overlapped with the circuit board is disposed more downstream of a flow of air directed from the imagers toward the air exhaust portion than the remaining imagers.

6. The projection display device according to claim 5, wherein
the air exhaust portion is provided with an exhaust fan, and an exhaust air passage formed between the imagers and the exhaust fan, and
the exhaust air passage and the exhaust fan are disposed such that the imager which is not overlapped with the circuit board is disposed more downstream of a flow of air directed from the imagers toward the exhaust fan through the exhaust air passage than the remaining imagers.
